(19) United States
(12) Patent Application Publication
(10) Pub. No.: US 2024/0054347 A1
(43) Pub. Date: Feb. 15, 2024

(54) SYSTEM AND METHOD OF TRAINING A NEURAL NETWORK MODEL

(71) Applicant: TECHNION RESEARCH & DEVELOPMENT FOUNDATION LIMITED, Haifa (IL)

(72) Inventors: Guy GILBOA, Haifa (IL); Rotem TURJEMAN, Haifa (IL); Tom BERKOV, Haifa (IL); Ido COHEN, Haifa (IL)

(21) Appl. No.: 18/231,968

(22) Filed: Aug. 9, 2023

Related U.S. Application Data
(60) Provisional application No. 63/396,658, filed on Aug. 10, 2022.

(51) Int. Cl. G06N 3/084; G06N 3/0464

(52) U.S. Cl. CPC G06N 3/084; G06N 3/0464

(57) ABSTRACT

A method and system for implementing a machine-learning (ML) based function may include providing a NN model comprising a plurality of NN parameters; training the NN model over a plurality of training epochs, to implement a predefined ML function, based on a training dataset; for one or more NN parameters of the plurality of NN parameters: (i) calculating a profile vector, representing evolution of the NN parameter through the plurality of training epochs; and (ii) calculating an approximated value of the at least one NN parameter, based on the profile vector; and replacing at least one NN parameter value in the trained NN model with a respective calculated approximated value, to obtain an approximated version of the trained NN model.

### CROSS-REFERENCE TO RELATED APPLICATIONS

This application claims the benefit of priority of U.S. Patent Application No. 63/396,658, filed Aug. 10, 2022, entitled “SYSTEM AND METHOD OF TRAINING A NEURAL NETWORK MODEL” which is hereby incorporated by reference in its entirety.

### FIELD OF THE INVENTION

The present invention relates generally to models of neural networks, for implementing a machine-learning based function. More specifically, the present invention relates to training machine-learning models, and/or implementing a machine-learning based function on machine-learning models.

### BACKGROUND OF THE INVENTION

Training of neural networks is a computationally intensive task. The significance of understanding and modelling the training dynamics is growing as increasingly larger networks are being trained.

### SUMMARY OF THE INVENTION

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

Embodiments of the invention may include an algorithm and model based on the correlation of the parameters' dynamics, which dramatically reduces the dimensionality. This algorithm and model may be referred to herein as Correlation Mode Decomposition (CMD). The algorithm is adapted to split the parameter space into groups of parameters, ansl referred to herein as “modes”, which behave in a highly correlated manner through the training epochs. The inventors have achieved a remarkable dimensionality reduction with this approach, where a network of 11M parameters such as a ResNet-18 network can be modelled well using just a few modes. The inventors have observed each typical time profile of a mode spread throughout the network in all layers. Moreover, retraining the network using the dimensionality reduced model of the present invention may induce a regularization which may yield better generalization capacity on the test set. Such representation can facilitate better future training acceleration techniques.

The inventors have observed that while the network parameters may behave non-smoothly in the training process, many of them are highly correlated and can be grouped into “modes”, characterized by their correlation to one common evolution profile. The present invention may thus include an algorithm, referred to herein as “Correlation Mode Decomposition” (CMD).

The CMD algorithm may model the network's dynamics in an efficient way in terms of dimensionality and computation time, facilitating significant reduction of dimensionality.

Experimental results have shown applicability of this approach to several popular architectures in computer vision (e.g., ResNet18). However, it may be appreciated by a person skilled in the art that application of the CMD algorithm should not be limited by any way to any specific NN or ML application.

Embodiments of the invention may include analysis of time-profiles, which in the neural-network setting is equivalent to examining the behavior of the network parameters, as they evolve through epochs of gradient descent.

Previous studies have shown that time-profiles and correlation analysis is beneficial in modeling nonlinear physical phenomena. These studies aimed to decompose the dynamic to orthogonal components both in space and in time. Imposing orthogonality in space and time, however, may be too strong of a constraint, leading to a limited solution space.

More recent studies in variational image-processing have shown that gradient descent with respect to homogeneous functionals (of various degrees) induce typical time profiles. For instance, total-variation flow can be modelled by piecewise linear time profiles. These profiles stem from the behavior of basic elements with respect to the gradient operator, referred to as nonlinear eigenfunctions. The theory developed there shows that the time profiles are generally not orthogonal. Orthogonality was shown in certain settings for the spatial structures (“spectral components”).

As elaborated herein, embodiments of the invention may generalize these concepts for the neural network case. A principal difference in the modelling is that unlike the variational case, here there is no guaranteed homogeneity, and the system is too complex to be modelled analytically. Embodiments of the invention may thus resort to data-driven time profiles, which change with network architectures and learning tasks.

Embodiments of the invention may include a method of training a NN model, by at least one processor. Embodiments of the method may include providing a NN model that includes a plurality of NN parameters, and training the NN model based on a training dataset over a plurality of training epochs, to implement a predefined ML function.

According to some embodiments, one or more (e.g., each) training epoch may include adjusting a value of at least one NN parameter based on gradient descent calculation; calculating a profile vector, representing evolution of the at least one NN parameter through the plurality of training epochs; calculating an approximated value of the at least one NN parameter, based on the profile vector; and replacing the at least one NN parameter value with the approximated value, to obtain an approximated version of the NN model.

Embodiments of the invention may include a system for implementing a machine-learning (ML)-based function. Embodiments of the system comprising: a non-transitory memory device, where modules of instruction code are stored, and at least one processor associated with the memory device, and configured to execute the modules of instruction code. Upon execution of said modules of instruction code, the at least one processor may be configured to provide a NN model that includes a plurality of NN parameters, and train the NN model based on a training dataset over a plurality of training epochs, to implement a predefined ML function. One or more (e.g., each) training epoch may include adjusting a value of at least one NN parameter based on gradient descent calculation; calculating a profile vector, representing evolution of the at least one NN parameter through the plurality of training epochs; calculating an approximated value of the at least one NN parameter, based on the profile vector; and replacing the at least one NN parameter value with the approximated value, to obtain an approximated version of the NN model.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting a computing device, which may be included within an embodiment of a system for training an ML model to implement a ML-based function, according to some embodiments;

FIG. 2 is a block diagram, depicting a system for training a ML model, and/or implementing a ML-based function, according to some embodiments of the invention;

FIG. 3 is an exemplary visualization of clustering of time profiles of a NN model into modes, as performed by embodiments of the present invention;

FIG. 4 includes plots that depict a spread of several modes, according to some embodiments of the present invention;

FIGS. 5A and 5B depict algorithms that may be employed by a system for training an ML model, and/or implementing a ML function, according to some embodiments of the invention;

FIGS. 6A-6D include plots depicting sampled weights from several modes, and their respective, approximated NN parameter values, as provided by some embodiments of the invention;

FIG. 7A-7B include plots depicting a comparison between implementation of an ML function by (i) a NN model, trained by a Gradient Descent (GD) algorithm, and (ii) CMD modelling of an approximated NN model, provided by embodiments of the invention;

FIG. 8 is a flow diagram depicting a method of training a ML model, and/or implementing a ML-based function, by at least one processor, according to some embodiments of the invention;

FIG. 9 is a flow diagram depicting a method implemented by at least one processor in accordance with some embodiments of the invention, for training a NN model, and optionally inferring the NN model on incoming data samples, to implement a ML-based function.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

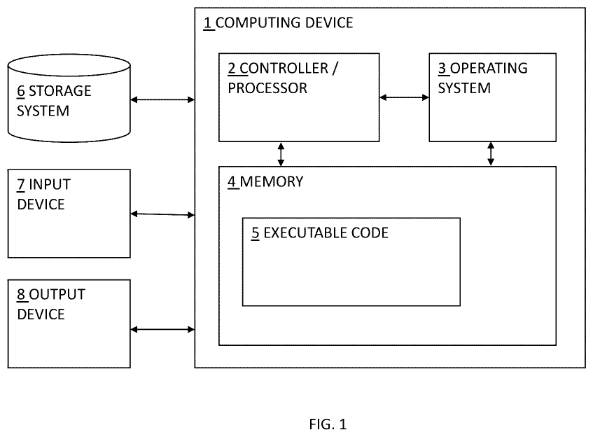

Reference is now made to FIG. 1, which is a block diagram depicting a computing device, which may be included within an embodiment of a system for training an ML model to implement a ML-based function, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may train an ML model, and/or implement a ML-based function as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to a ML model to be trained may be stored in storage system 6, and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

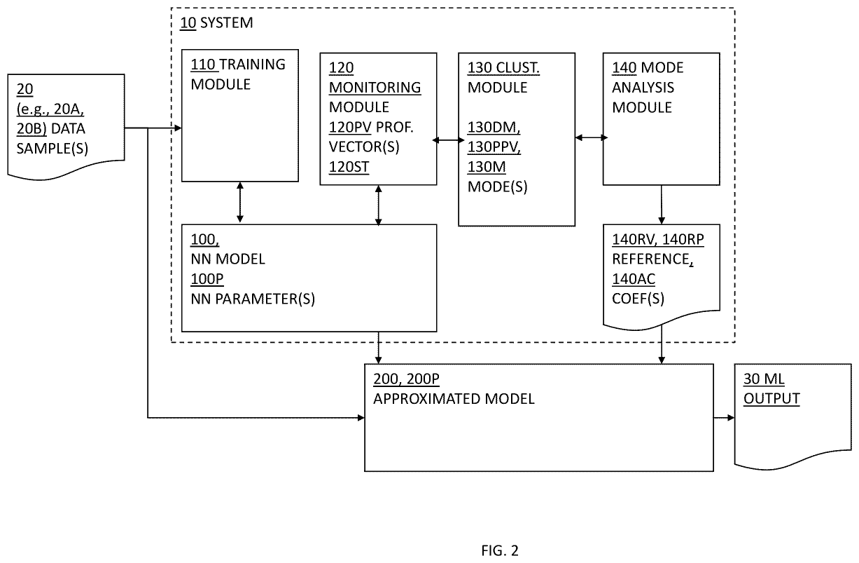

Reference is now made to FIG. 2, which is a block diagram depicting a system 10 for training a ML model, and/or implementing a ML-based function, according to some embodiments of the invention. System 10 may be implemented as a software module, a hardware module, or any combination thereof. For example, system 10 may be or may include a computing device such as element 1 of FIG. 1, and may be adapted to execute one or more modules of executable code (e.g., element 5 of FIG. 1) to train an ML model, and/or implement an underlying ML-based function, as further described herein.

As shown in FIG. 2, arrows may represent flow of one or more data elements to and from system 10 and/or among modules or elements of system 10. Some arrows have been omitted in FIG. 2 for the purpose of clarity.

As shown in FIG. 2, system 10 may receive (e.g., from input 7 of FIG. 1) an ML model 100, which may, for example, be based on an NN architecture. The terms ML model 100 and NN model 100 may thus be used herein interchangeably. NN model 100 may include a plurality of NN parameters 100P. The terms “parameters” may refer to any configurable parameter or hyperparameter of an NN model or architecture as known in the art, including, for example NN weights. Additionally, or alternatively, the terms parameters 100P and weights 100P may be used herein interchangeably.

As elaborated herein, system 10 may produce an approximated version 200 of ML model 100. The terms ML model 200 and NN model 200 may thus also be used herein interchangeably.

According to some embodiments, system 10 may include, or may be associated with a training module 110. Training module 110 may be configured to train NN model 100 to implement an underlying ML-based function (e.g., a Natural Language Processing (NLP) function, an image analysis function, and the like), based on a plurality of data samples 20 (e.g., training data samples 20A). The training process may, for example, be a supervised training algorithm, that may employ Stochastic Gradient Descent (SGD) to modify NN parameters 100P over a plurality of training epochs, as known in the art.

According to some embodiments, system 10 may analyze evolution of NN parameters 100P during the training process, and subsequently produce an approximated version, or approximated model 200 of the trained NN model 100, based on the analysis. System 10 may subsequently implement the ML-based function by inferring approximated model 200 on data samples 20 (e.g., test data samples 20B).

Embodiments of the invention may include a practical application by improving functionality of a computing system: As elaborated herein, by inferring the approximated version of NN model 200 on incoming data samples 20 (e.g., rather than inferring the trained NN model 100 on data samples 20), system 10 may improve implementation of the underlying ML function. This improvement is manifested, for example by improved metrics of accuracy, as elaborated herein.

According to some embodiments, system 10 may include a monitoring module 120, configured to monitor evolution of one or more (e.g., each) NN parameter 100P during the training process (e.g., over the plurality of training epochs). For example, monitoring module 120 may calculate, for one or more NN parameters 100P of the plurality of NN parameters 100P a profile vector 120PV that represents evolution or change of a value of the NN parameter over time (e.g., throughout the plurality of training epochs).

For example, a specific profile vector 120PV may be, or may include a vector of numerical values, representing values of a specific, respective NN parameter 100P at different points in time during the training process, e.g., following each training epoch.

According to some embodiments, system 10 may include a clustering module 130, configured to analyze profile vectors 120PV, to determine disjoint sets of NN parameters 100P.

Clustering module 130 may thus group, or cluster the NN parameters 100P such that each group or cluster may have, or may be characterized by a different prototypical profile vector 130PPV. These groups may be referred to herein interchangeably as “clusters” or “modes” 130M. The prototypical profile vectors 130PPV of each cluster 130M may be calculated as best representing the plurality of profile vectors 120PV of member parameters 100P according to a predetermined distance metric 130DM. For example, a prototypical profile vector 130PPV of a mode 130M may include point-mean values of corresponding entries of member profile vectors 120PV.

According to some embodiments, clustering module 130 may group or cluster the plurality of NN parameters 100P into a plurality of modes 130M, based on their respective profile vectors 120PV.

For example, clustering module 130 may calculate a distance metric (e.g., a Euclidean distance) 130DM between pairs of profile vectors 120PV, each representing a specific NN parameter 100P. Clustering module 130 may subsequently cluster the NN parameters 100P into multidimensional clusters, or modes 130M based on the calculated di stance metric 130DM.

As elaborated herein, each NN parameter 100P may correspond to, or be represented by a specific prototypic profile vector 130PPV. Therefore, each cluster or mode may be regarded herein as clustering member both NN parameters 100P and/or clustering their respective member profile vectors 120PV.

For example, NN model may implement a binary classification function between images of cats and dogs. In this non-limiting example, NN model 100 may be a Convolutional Neural Network (CNN) model, as known in the art. The inventors have experimentally implemented this CNN model 100 by a model referred to herein as “SimpleNet2”. The SimpleNet2 model used in this example was a NN model that included several convolution layers, followed by max-pooling layers, fully-connected (FC) layers and Rectified Linear Unit (ReLU) activation layers, culminating at a total of 94,000 NN parameters 100P.

The term NN parameter 100P may be used herein to refer to any elements of a NN model that may be adapted during training to perform an underlying function. For example, NN parameters of SimpleNet2 may include NN weight values, that may be changed during a training stage by an SGD algorithm, to facilitate the underlying function of classifying images of cats and dogs.

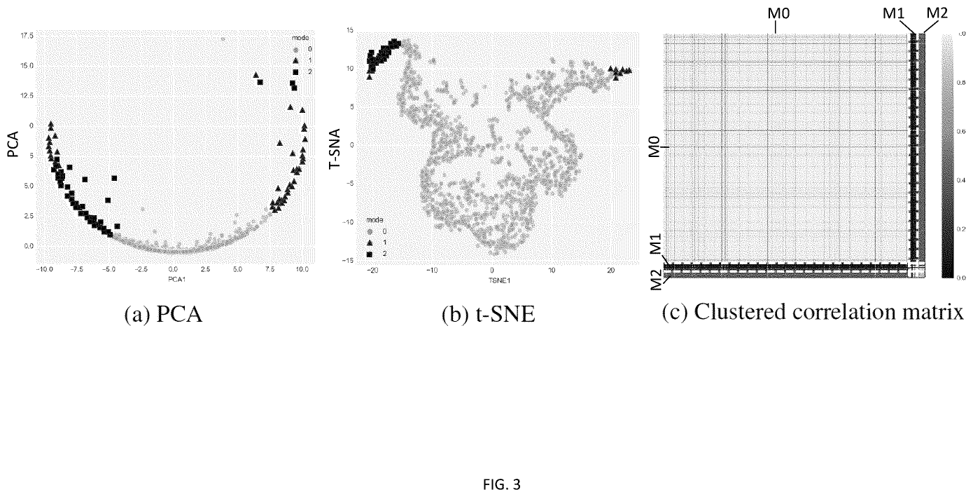

Reference is also made to FIG. 3, which depicts an exemplary visualization of clustering of time profiles of a NN model 100 (e.g., SimpleNet2) into modes 130M, as performed by embodiments of the present invention.

When examining the evolution of NN parameters 100P (e.g., NN weights) during the training process, it has been observed that the general characteristics of the profile vectors 120PV are very similar throughout NN model 100. Following normalization of the mean, variance, and sign there are essentially very few characteristic profile vectors 120PV which represent the entire dynamics. Moreover, these profiles 120PV are spread throughout the NN model 100, and can be extracted by uniform sampling of a small subset of the entire network parameters 100P. To illustrate this, the inventors have sampled 1000 weights of the NN parameters 100P (e.g., approximately 1% of SimpleNet2's NN parameters) and clustered them into 3 main modes, based on the correlations between the weights in this sub set.

Panel (c) of FIG. 3 depicts a clustered correlation matrix of the sampled NN parameters. Dashed lines separate the modes 130M, denoted here as modes M0, M1, and M2. The mode numbers (M0, M1, M2) are shown on the top and left margins of the matrix. In panel (c) of FIG. 3, one can easily notice that the NN parameters (e.g., NN weights) 100P are indeed divided into highly distinct modes 130M. The inventors subsequently associated each of the rest of the CNN's parameters 100P (e.g., other than the sampled 1000 parameters 100P) to the mode 130M they are most correlated to.

As known in the art, Principal Component Analysis (PCA) is a statistical technique for reducing the dimensionality of a dataset, thereby increasing interpretability of data while preserving the maximum amount of information, and enabling visualization of multidimensional data. Panel (a) of FIG. 3 depicts PCA projection of 3,000 random samples of NN parameters 100P (e.g., NN weights), and their related modes 130M.

As known in the art, t-distributed stochastic neighbor embedding (t-SNE) is a statistical method for visualizing high-dimensional data by giving each datapoint a location in a two or three-dimensional map. Panel (b) of FIG. 3 depicts a t-SNE visualization of the 3000 random samples.

The PCA representation of panel (a) shows clear separation of the modes 130M among the sampled parameters 100P. The t-SNE plot of panel (b) shows that the two smaller modes (M1, M2) are represented as concentrated clusters, whereas the main mode (M0) is more spread out.

According to some embodiments, clustering module 130 may be configured to group or cluster NN parameters 100P into clusters or modes 130M based on a metric of correlation between NN parameters 100P.

For example, for one or more pairs of NN parameters 100P, clustering module 130 may calculate a distance metric 130DM such as a correlation value, representing correlation between (i) a profile vector 120PV of a first NN parameter 100P of the pair and (ii) a profile vector 120PV of a second NN parameter 100P of the pair. Clustering module 130 may subsequently group at least a portion of the plurality of NN parameters 100P as members of the plurality of modes or clusters 130M, based on the calculated correlation values 130DM. For example, clustering module 130 may assign NN parameters 100P corresponding to respective, highly correlated profile vectors 120PV as members of the same mode or cluster 130M.

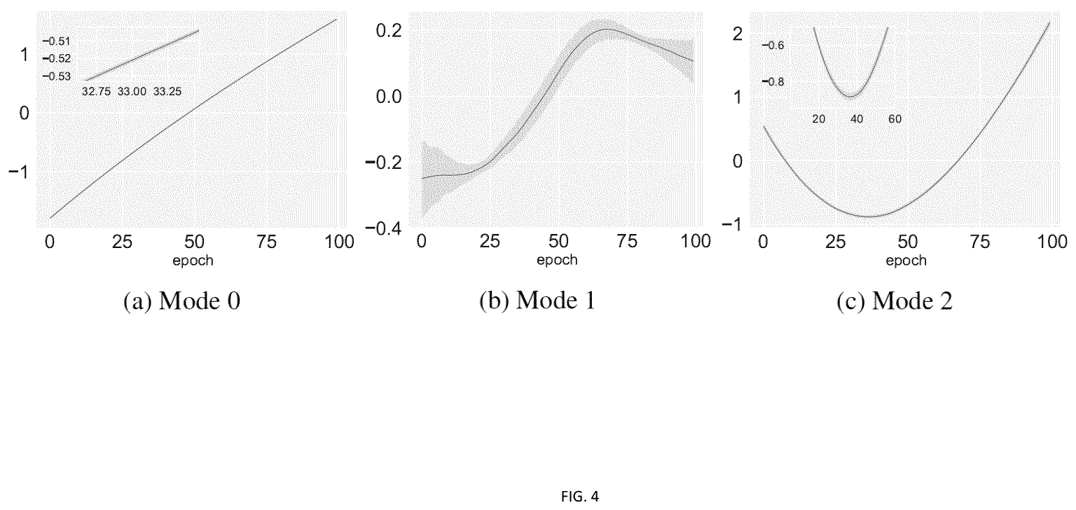

Reference is now made to FIG. 4, which includes plots depicting a spread of several modes 130M (M0, M1 and M2), according to some embodiments. In each plot, a reference profile vector 140RV, which is most correlated to all other parameters in that mode or cluster (e.g., a “cluster center”) was selected. In some embodiments, reference profile vector 140RV may be the same as the prototypic profile vector 130PPV of clustering module 130, as elaborated herein.

In the example of FIG. 4, a 95% confidence interval of that mode was calculated in relation to the respective reference profile vector 140RV. It may be clearly observed that mode 130M M0 and mode 130M M2 are highly condensed clusters (e.g., characterized by a relatively small variance), whereas mode 130M M1 is more spread-out.

The inventors have hypothesized that the dynamics of parameters of NN model 100 can be clustered into very few, highly correlated groups or modes 130M.

Let N be the number of network parameters 100P, and M be the number of modes or clusters 130M, also denoted {C1, . . . , CM}. It may be appreciated that the number of clusters 130M M may be much smaller (e.g., in several orders of magnitude) than number of network parameters 100P N. For example, N may be in the order of thousands, whereas M may be in the order of a dozen.

A correlation between two profile vectors 120PV may be defined according to equation Eq. 1A, below:

$$corr ( u , v ) = \frac{\text{?}}{‖ \text{?} ‖ ‖ \text{?} ‖} \qquad Eq . 1 A$$

$$\text{?} \text{indicates text missing or illegible when filed}$$

where the u and v represent the profile vectors 120PV,
and ū v̅ denote a centralized weight as in Eq. 1B below (taking ū as an example):

ū=u−Σₖ₌₀^{T}u^{k} Eq. 1B

In Eq. 1B, T is the length or number of entries (e.g., number of epochs) of profile vectors 120PV.

In Eq. 1A, [symbol] ⋅,⋅ [symbol] represents the Euclidean inner product over the indices of profile vectors 120PV (e.g., the epoch axis), as in Eq.1C below:

[symbol]

u,v [symbol] =Σₖ₌₀^{T}u^{k}v^{k} Eq. 1C

A small threshold parameter ϵ, 0<ϵ<<1 (e.g., ϵ=0.01) may be defined. Based on these definitions, a pair of profile vectors 120PV (denoted as wi,wj) may be determined as correlated, and thereby clustered as members of a mode 130M, when Eq. 1D below is satisfied:

|corr(wi,wj)|≥1−ϵ, ∀wi,wj∈Cm, m=1, . . . ,M. Eq. 1D

Thus, any two parameters 100P (e.g., w₁, w₂) of a specific mode m (w^{m}₁, w^{m}₂) which are perfectly correlated (or anti-correlated), yielding |corr(w^{m}₁, w^{m}₂)|=1, can be expressed as an affine transformation of each other as in Eq. 2A, below:

w^{m}₁=a·w^{m}₂+b, where a,b∈R. Eq. 2A

This leads to the approximation of the dynamics, as elaborated in equation Eq. 2B, below:

w^{m}ᵢ≈ai·w^{m}ᵣ+bᵢ, ∀wᵢ,wᵣ∈Cₘ, m∈{1, . . . ,M} Eq. 2B

In Eq. 2B, w^{m}ᵣ may represent a reference NN parameter (e.g., weight) 140RP corresponding to a reference profile vector 140RV in the m^{th} cluster or mode 130M. Additionally, aᵢ, bᵢ may represent affine coefficients 140AC corresponding to the i^{th} NN parameter (e.g., weight) 100P of the respective m^{th} cluster or mode 130M (or the the i^{th} parameter vector 120PV the in the m^{th} cluster or mode 130M). Additionally, w^{m}ᵢ may represent a reconstructed version, or approximated version 200P of the i^{th} NN parameter 100P (e.g., weight 100P) of NN model 100.

In other words, as shown by Eq. 2B, system 10 may represent, or reconstruct an approximation of one or more (e.g., each) NN parameter 100P or weight 100P w^{m}ᵢ, based on (i) a mode-specific reference NN parameter 100P w^{m}ᵣ and (ii) affine coefficients 140AC aᵢ, bᵢ that are parameter-specific (e.g., the i^{th} NN parameter).

Embodiments of the invention may include several options for choosing the number of modes M. For example, clustering module 130 may find a minimum threshold so that the cophenetic distance between any two original observations in the same cluster does not exceed the threshold, where no more than M clusters are formed.

In another example, clustering module 130 may form clusters so that the original observations in each cluster may have no greater a cophenetic distance than a desired threshold.

For example, to find affine coefficients 140AC a and b, embodiments of the invention may perform the following computation of equation Eq. 3, below:

$$\{ A , B \} = {arg min}_{A , B} {‖ {W}_{m} - {Aw}_{r , m} + B ‖}_{2}^{} , \qquad Eq . 3$$

where Wₘ∈ [symbol] ^{|C}^{ₘ}^{|×T} is a matrix of all weight dynamics in the mode Cm,
A∈ [symbol] ^{|C}^{ₘ}^{|×1} is the vector of coefficients aᵢ 140AC,
B∈ [symbol] ^{|C}^{ₘ}^{|×1} is the vector of free terms bᵢ 140AC and
[symbol] ∈ [symbol] ^{1×T} is a row vector of ones.

By defining the matrix Ã 140AC as [A B], and

$${\tilde{w}}_{r , m} := [ \begin{matrix}{w}_{r , m} \\ \end{matrix} ]$$

the relation of Eq. 4 may be achieved:

$$\tilde{A} = {arg min}_{\tilde{A}} {‖ {W}_{m} - \tilde{A} {\tilde{w}}_{r , m} ‖}_{2}^{} \qquad Eq . 4$$

where F is the Frobenius norm. This yields the solution of:

Ã=Wₘ\tilde{w}_{r,m}^{T}(\tilde{w}_{r,m}\tilde{w}_{r,m}^{T})⁻¹ Eq. 5

thereby calculating affine coefficients 140AC.

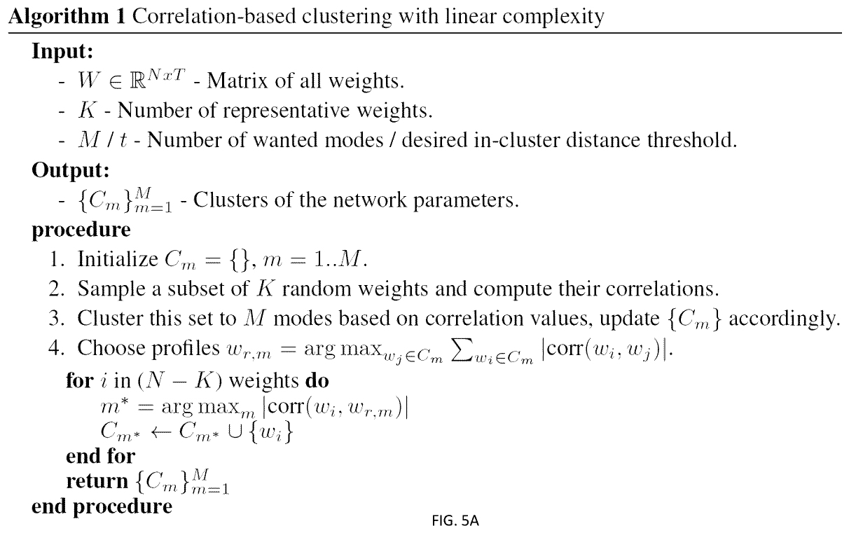

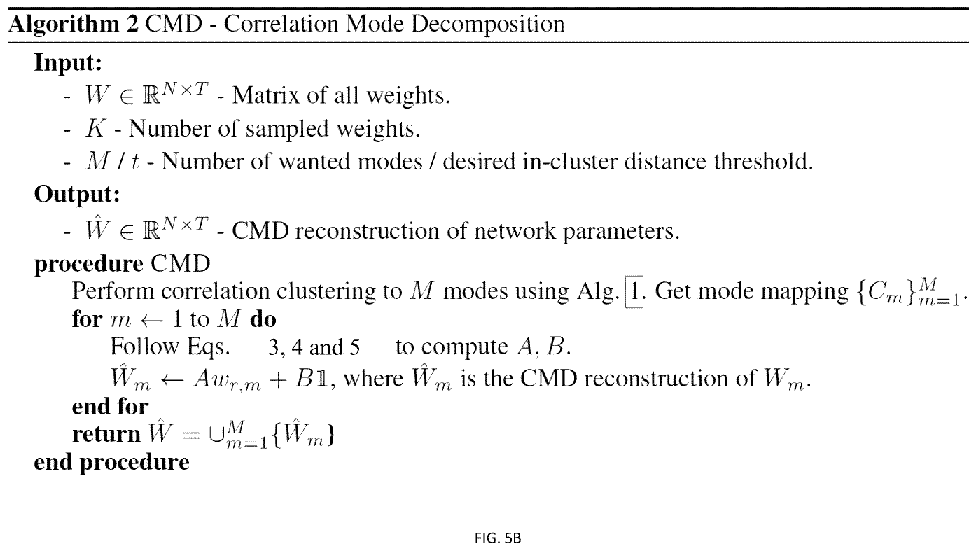

Reference is now made to FIG. 5A, depicting an algorithm, referred to herein as “Algorithm 1”, that may be employed by a system 10 (e.g., by clustering module 130) for implementing a ML function for clustering NN parameters 100P into modes 130M, according to some embodiments.

As shown in FIG. 2, system 10 may further include an analysis module 140, configured to extract, from one or more modes 130M, information that may allow representation, and reconstruction of member NN parameters 100P of that node. This information may include a reference NN parameter 140RP (e.g., w^{m}ᵣ of Eq. 2B) and affine coefficients 140AC (e.g., aᵢ, bᵢ of Eq. 2B).

As elaborated herein, reference NN parameter 140RP may, for example, be an NN parameter 100P that corresponds to a central member reference profile vector 140RV. The term “central” may be used in this context to indicate a specific member NN parameter 100P that is located nearest a center of a multidimensional space defined by the respective cluster 130. Alternatively, the central member NN parameter 100P may be defined as one having a minimal distance metric value from all other member NN parameters 100P of that cluster 130 (e.g., as shown in FIG. 4).

Additionally, analysis module 140 may calculate specific affine coefficients 140AC (e.g., aᵢ, bᵢ of Eq. 2B) for one or more (e.g., each) member (e.g., i^{th} member) NN parameter 100P.

Reference is also made to FIG. 5B, depicting an algorithm, referred to herein as “Algorithm 2”, that may be employed by a system 10 (e.g., by analysis module 140), to extract affine coefficients 140AC (denoted A and B), according to some embodiments.

Estimating the correlation between N variables typically needs an order of N² computations (every variable with every other variable). This can be problematic for large networks where N can be in the order of millions, or even billions. However, as summarized in Eqs. 1A-1D and Eqs. 2A-2B, embodiments of the invention (e.g., clustering module 130) may perform clustering of NN parameters 100P without computing the full correlation matrix. Instead, clustering module 130 may perform clustering of NN parameters 100P with computational complexity in the order of N·M·T, where M is the number of modes and T is the number of epochs.

For example, instead of computing the entire correlation matrix, clustering module 130 may compute the correlations only between the network weights 100P and the reference weights 140RP of each mode, which were found earlier in a sampling phase. The estimation procedure is described in Algorithm 1. The complexity is approximated as K²·T+(N−K)·M·T≈N·M·T, where the number of sampled parameters K can be in the order of 30×M to provide sufficient statistics. In their experiments, the inventors have used the value of K=1000, under the assumption that the K sampled weights may represent all essential modes 130M of NN model 100.

According to some embodiments, and as elaborated herein (e.g., in relation to Eqs. 2A-2B), system 10 may calculate an approximated value 200P of at least one NN parameter 100P based on the grouping of NN parameters 100P into modes.

In other words, system 10 may represent, or reconstruct an approximation of one or more (e.g., each) NN parameter 100P or weight 100P w^{m}ᵢ, based on (i) a mode-specific reference NN parameter 100P w^{m}ᵣ and (ii) parameter-specific affine coefficients 140AC (aᵢ, bᵢ) of NN parameter 100P w^{m}ᵢ that are members of that mode.

Additionally, or alternatively, for at least one (e.g., each) NN parameter 100P w^{m}ᵢ of the plurality of NN parameters 100P, system 10 may calculate an approximated value 200P of the at least one NN parameter w^{m}ᵢ, based on the corresponding profile vector 120PV.

In other words, for at least one (e.g., each) mode 130M, analysis module 140 may select a first NN parameter 100P, associated with the at least one mode (e.g., w^{m}ᵢ), as a reference NN parameter 140RP w^{m}ᵣ. Mode analysis module 140 may subsequently calculate a value of one or more affine function coefficients 140AC (e.g., A and B of Algorithm 2, or aᵢ, bᵢ of Eq. 2B), representing a transform between reference NN parameter 140RP w^{m}ᵣ and at least one corresponding second NN parameter 100P w^{m}ᵢ, associated with the at least one mode 130M. System 10 may subsequently calculate an approximated value 200P w^{m}ᵢ of the at least one second NN parameter 100P w^{m}ᵢ based on: (i) the reference NN parameter 140RP w^{m}ᵣ, and (ii) the one or more corresponding affine function coefficient values 140AC (aᵢ, bᵢ of Eq. 2B), as elaborated herein (e.g., in relation to Eq. 2B).

Additionally, or alternatively, system 10 may be configured to replace at least one NN parameter 100P w^{m}ᵢ value in the trained NN model 100 with a respective calculated, approximated NN parameter 200P w^{m}ᵢ value. System 10 may thus produce, or obtain an approximated version 200 of trained NN model 100.

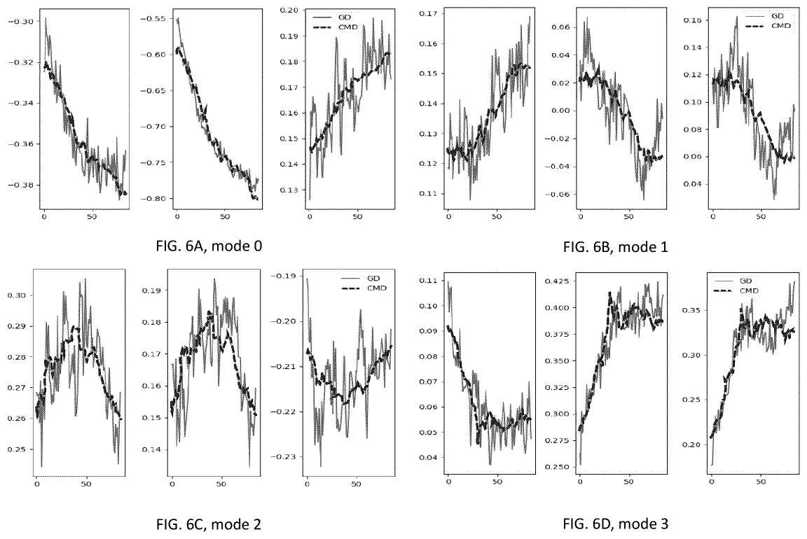

Reference is now made to FIGS. 6A-6D, which includes plots depicting sampled parameters or weights 100P over time (e.g., parameter vectors 120PV, solid line) from several modes 130M, that were changed based on gradient descent. Additionally, each plot includes the respective, approximated NN parameter 200P values (dashed line), as provided by embodiments of the present invention. FIGS. 6A-6D refer to four different modes, enumerated mode0-mode3 respectively.

It may be evident from FIGS. 6A-6D, that the CMD modelling of the present invention may provide stable, less oscillatory convergence of NN parameters over time (e.g., over epochs).

As elaborated herein, NN model 100 may be trained to implement a specific, underlying ML function. In other words, NN model 100 may be inferred on incoming data samples 20B (e.g., images of cats and dogs) to apply the specific, underlying ML function (e.g., classify, or distinguish between types of depicted animals), based on the training. In this example, an output of the ML function (30 of FIG. 2) would be labelling of a new image as portraying the animal type.

According to some embodiments, system 10 may utilize approximated NN model 200, instead of NN model 100 to implement the underlying ML function. In other words, at an inference stage, or a testing stage, system 10 may receive at least one input data sample 20B (e.g., image of an animal), and may infer the approximated version 200 of NN model 100 on input data sample 20B, to implement the ML function (e.g., to classify the depicted animal) on the input data sample 20B.

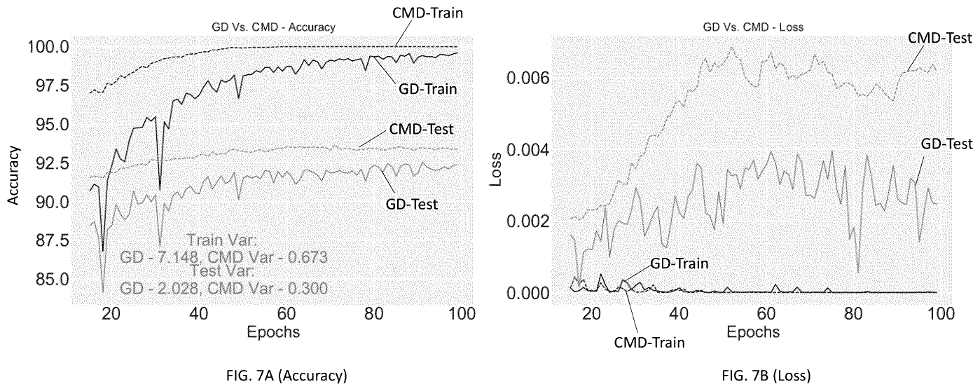

Reference is now made to FIGS. 7A-7B, which include plots depicting a comparison between implementation of an ML function by (i) a NN model 100, trained by a Gradient Descent (GD) algorithm, and (ii) a CMD modelling of approximated NN model 200, provided by embodiments of the invention.

Panel (a) of FIG. 7 represents comparison between the two models based on accuracy. Panel (b) of FIG. 7 represents comparison between the two models based on a loss function value.

It may be observed that CMD may follow GD well during the training process. Additionally, for the testing, or validation set, CMD is more stable, and may surpass GD for both quality criteria.

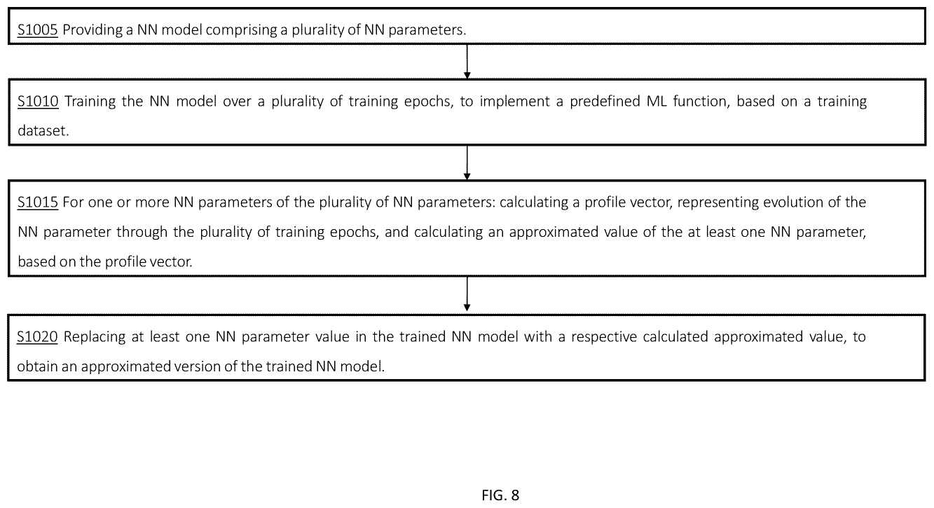

Reference is now made to FIG. 8 which is a flow diagram depicting a method of training a ML model, and/or implementing a ML-based function, by at least one processor (e.g., processor 2 of FIG. 1) according to some embodiments of the invention.

As shown in step S1005, the at least one processor may receive (e.g., via input 7 of FIG. 1), or provide a NN model (e.g., NN model 100 of FIG. 2), that may include a plurality of NN parameters 100P or weights.

As shown in step S1010, and as elaborated herein (e.g., in relation to FIG. 2), the at least one processor 2 may employ a training module (training module 110) to train NN model 100, to implement a predefined ML function. Processor 2 may train NN model 100 over a plurality of training epochs, based on a training dataset (e.g., element 20A of FIG. 2).

As shown in step S1015, and as elaborated herein (e.g., in relation to FIG. 2), for one or more NN parameters 100P of the plurality of NN parameters, the at least one processor 2 may calculate a profile vector 120PV. Profile vector 120PV may represent evolution of the relevant NN parameter 100P through the plurality of training epochs. Additionally, as elaborated herein (e.g., in Eq. 2B), processor 2 may calculate an approximated value 200P of the at least one NN parameter 100P, based on profile vector 120PV.

As shown in step S1020, processor 2 may replace at least one NN parameter 100P value in the trained NN model 100 with a respective calculated approximated value 200P, to obtain an approximated version 200 of the trained NN model 100.

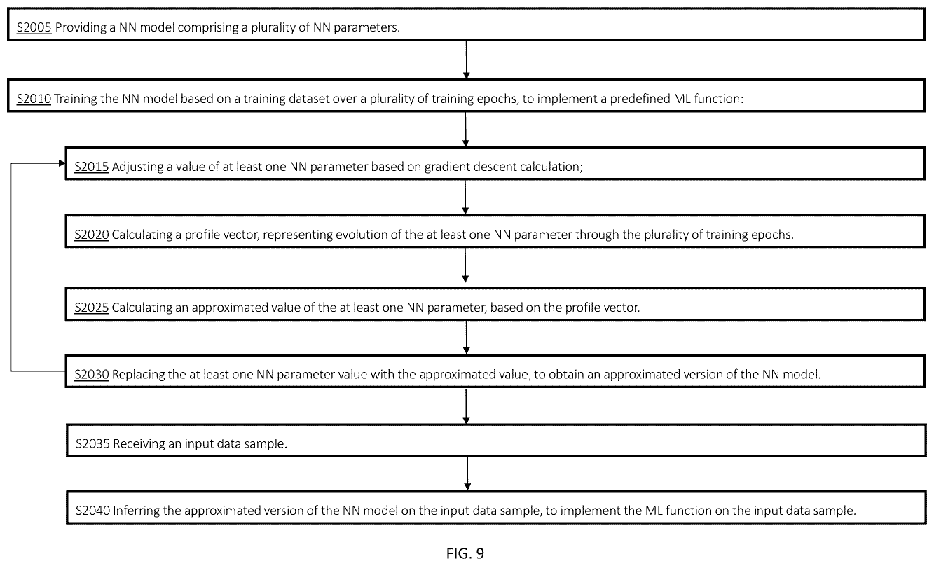

Reference is now made to FIG. 9, which is a flow diagram depicting a method implemented by at least one processor (e.g., processor 2 of FIG. 1) in accordance with some embodiments of the invention, for training a NN model, and optionally inferring the NN model on incoming data samples, to implement a ML-based function as elaborated herein.

As shown in step S2005, the at least one processor may receive (e.g., via input 7 of FIG. 1), or provide a NN model (e.g., NN model 100 of FIG. 2), that may include a plurality of NN parameters or weights (e.g., 100P of FIG. 2).

As shown in step S2010, and as elaborated herein (e.g., in relation to FIG. 2), the at least one processor 2 may employ a training module (e.g., training module 110 of FIG. 2) to train NN model 100, to implement a predefined ML function. Processor 2 may train NN model 100 over a plurality of training epochs, based on a training dataset (e.g., element 20A of FIG. 2).

As a non-limiting example, training dataset 20A may be a set of animal pictures, annotated by the animals' types, and the predefined ML function may include identification of cats from dogs in new, incoming data samples 20B of images.

Processor 2 may train NN model 100 continuously, or repeatedly over time, as shown by the arrow connecting step S2030 to step 2015. Each epoch of the training process may include at least one operation as described herein in steps S2015-S2030.

Additionally, as elaborated herein, the training process may be performed in at least two stages:

At a preliminary stage, NN model may be initially trained such that NN weights 100P of model 100 are adjusted, e.g., based on Gradient Descent (GD) calculation. The NN parameters or weights 100P of the NN model may subsequently be grouped or clustered into modes (e.g., 130 of FIG. 2).

At a subsequent stage, NN model may be trained such that NN weight 100P values are gradually replaced with approximated values (e.g., 200P of FIG. 2), thereby avoiding, or refraining from calculation of GD for those NN parameters or weights 100P.

As shown in step S2015, and as elaborated herein (e.g., in relation to FIG. 2), in one or more (e.g., each) training epochs, training module 110 may employ gradient descent calculation, or any other appropriate algorithm as known in the art, to adjust a value of at least one NN parameter 100P. The training process may not be limited to any specific paradigm, and may include supervised training, unsupervised training, or any combination thereof.

As shown in step S2020, the at least one processor 2 may employ a monitoring module (120 of FIG. 2) to calculate, or aggregate a profile vector 120PV that represents evolution of values of the at least one NN parameter 100P through the plurality of training epochs.

As shown in steps S2025, and 2030, and as elaborated herein (e.g., in relation to Eq. 2B), the at least one processor 2 may calculate an approximated value 200P of the at least one NN parameter 100P, based on the profile vector 120PV. The at least one processor 2 may subsequently replace the at least one NN parameter 100P value with the approximated value 200, to obtain an approximated version 200 of the NN model 100.

As elaborated herein, the approximated version 200 of the NN model 100 may present several benefits for implementing ML functions:

During training or testing phases, where weights 100P are gradually replaced by their respective approximated values 200P, the required calculation of GD for adjusting weights in NN 100 diminishes over time, thereby saving processing time and resources.

Additionally, the substitute NN model, which may be based upon approximation values 200P may be significantly smaller than brute-force trained NN models, as typically performed in the art, allowing ease of deployment, storage and application of the underlying ML function.

For example, and as shown in steps S2035 and S2040, during inference of the substitute, approximated NN model 200, the at least one processor 2 may receive an input data sample (e.g., 20B of FIG. 2). The at least one processor 2 may subsequently infer the approximated version 200 of the NN model 100 on the input data sample 20B, to implement the ML function on the input data sample 20B.

It may be appreciated that NN model 100 may be implemented as a separate software and/or hardware module from the approximated version 200, as depicted in the non-limiting example of FIG. 2. Additionally, or alternatively, NN model 100 may be implemented as the same software and/or hardware module as that of approximated version 200. For example, as weights of NN model 100 are gradually replaced by approximated values 200P, NN model is gradually transformed into the approximated NN version 200.

As elaborated herein, the process of training NN 100 (and creating approximated NN version 200) includes a preliminary stage, during which processor 2 may utilize training module 110 to train NN model 100 based on training dataset 20A, over a first bulk of training epochs. During, or subsequent to this preliminary training, preliminary profile vectors 129PV are formed, as elaborated herein.

Processor 2 may employ a clustering module (130 of FIG. 2) to group the plurality of NN parameters 100P as members of modes, based on their respective, preliminary profile vectors 120PV, e.g., based on correlation of their profile vectors 120PV, as elaborated herein (e.g., in relation to Eqs. 1A-1D, FIG. 2 and FIG. 3).

As elaborated herein (e.g., in relation to) processor 2 may proceed to calculate the approximated values 200P of member NN parameters 100P based on the grouping into modes.

For example, and as elaborated herein (e.g., in relation to Eqs. 1A-1D), for one or more pairs of NN parameters 100P, clustering module 130 may calculate a correlation value representing a correlation between (i) a profile vector 120PV of a first NN parameter 100P of the pair and (ii) a profile vector 120PV of a second NN parameter 100P of the pair. Clustering module 130 may then group or cluster the plurality of NN parameters as members of modes 130M based on the calculated correlation values, e.g., by grouping together NN parameters 100P that have highly correlated (e.g., beyond a predefined threshold) profile vectors 120PV.

As elaborated herein, for one or more (e.g., each) modes 130M, processor 2 employ an analysis module 140 to obtain or select a NN parameter 100P, member of mode 130M, as a reference parameter (140RP of FIG. 2). Additionally, or alternatively, analysis module 140 may select a profile vector 120PV, corresponding to reference parameter 140RP as a reference profile vector (140RV of FIG. 2).

For example, analysis module 140 may identify a central member NN parameter 100P of the mode 130M, as one located nearest a center of a multidimensional space defined by the respective mode 130M, and subsequently select the profile vector 120PV of the central member NN parameter 100P as the reference profile vector 140RV.

In another example, analysis module 140 may identify a central member NN parameter 100P of the mode 130M as one having a minimal distance value from other member NN parameters of the mode 130M, in the multidimensional space defined by mode 130M, according to a predetermined distance metric (e.g., a Euclidean distance). Processor 2 may select the profile vector 120PV of the central member NN parameter 100P as the reference profile vector 140RV.

As elaborated herein (e.g., in relation to Eqs. 3-5), for one or more (e.g., each) NN parameter 100P, analysis module 140 may calculate a value of one or more affine function coefficients 140AC (e.g., aᵢ, bᵢ of Eq. 2B). Affine function coefficients values 140AC may represent a transform between the reference NN parameter 140RP of a mode 130M and at least one second NN parameter 100P, member of the same mode 130M.

As elaborated herein (e.g., in relation to Eq. 2B) analysis module 140 may calculate the approximated value 200P of the at least one second NN parameter based on: (i) the reference NN parameter value 140RP (e.g., w^{m}ᵣ of Eq. 2B), and (ii) the one or more corresponding affine function coefficient values 140AC (e.g., aᵢ, bᵢ of Eq. 2B).

Additionally, or alternatively, analysis module 140 may, for at least one mode 130M of the plurality of modes, obtain a reference profile vector, characterizing evolution of NN parameters of the mode through the plurality of training epochs, as elaborated herein, e.g., in relation to FIGS. 6A-6D.

Analysis module 140 may calculate a value of one or more affine function coefficients 140AC (e.g., aᵢ, bᵢ of Eq. 2B), associated with one or more specific NN parameters 100P of the same mode 130M. As elaborated herein, the affine function coefficients 140AC may represent a transform between (i) the profile vectors 120PV of the one or more specific NN parameters 100P and (ii) the reference profile vector 140RV.

Analysis module 140 may subsequently calculate the approximated value of the one or more specific NN parameters based on: (i) the reference profile vector 140RV, and (ii) the one or more affine function coefficient values 140AC, as elaborated herein (e.g., in relation to Eq. 2B).

According to some embodiments, during training of NN model 100, and subsequent generation of substitute NN version 200, monitoring module 120 may optimize utilization of processing resources (e.g., CPU cycles and/or memory).

For example, for at least one NN parameter 100P of the plurality of NN parameters, analysis module 110 may recalculate the associated affine function coefficient values 140AC between training epochs. It may be appreciated that during early stages of training, affine function coefficient values 140AC may be jittery, and may become more stable as the training of NN 100 gradually converges.

Monitoring module 120 may monitor coefficient values 140AC, to determine a status of stability 120ST of the affine function coefficient values, among consecutive training epochs, according to a predetermined stability metric. For example, status of stability 120ST may be a numerical value, representing the percentage or portion of jitter in the value of a coefficient 140AC, between two consecutive epochs. Other values stability status 120ST may also be possible.

According to some embodiments, training module may train, or freeze specific weights or parameters 100P of NN 100, based on the stability status 120ST.

For example, when stability status 120ST of a specific parameter 100P surpasses a predetermined threshold, that parameters 100P may be deemed stable. Training module 110 may then refrain from calculating gradient descent of the at least one NN parameter 100P, thereby reducing system complexity and processing power. In other words, training module 110 may proceed to calculate gradient descent, and adjust weights 100P only for weights 100P that their stability status 120ST has not surpassed the predetermined threshold.

In some embodiments, training module may then replace the value of that stable NN parameter 100P from one that is calculated between epochs, e.g., by calculation of gradient descent, to the approximated value 200P, which is related to the value of reference parameter 140RP e.g., via Eq. 2B.

As elaborated herein, system 10 may provide a practical application, by providing several improvement to functionality of computer-based systems, configured to implement ML based functions.

For example, by inferring the approximated version of NN model 200 on incoming data samples 20 (e.g., rather than inferring the trained NN model 100 on data samples 20), system 10 may provide an improvement in implementation of the underlying ML function. This improvement is manifested, for example by improved metrics of accuracy, as elaborated herein. In other words, by using the approximated model (as in FIG. 2), embodiments of the invention may achieve an improved NN model (e.g., improved NN parameter 100P values), e.g., in terms of classification accuracy, as depicted in FIG. 7.

Additionally, embodiments of the invention may use the CMD modelling of approximated ML model 200 to accelerate, and/or improve training of an ML model.

For example, the CMD algorithm may be used to efficiently retrain an ML model following some unexpected change e.g., in a loss function or dataset. In other words, ML model 100 (or ML model 200) may be initially trained, based on a given dataset and loss function. Subsequently, in a condition that a parameter in the loss function should be changed, or when there is a change or drift in the dataset, the previously trained model (100/200) should be retrained. Embodiments of the invention may expediate this retraining procedure by (a) only training or amending reference weights 140RP (e.g., using a gradient-descent algorithm) and (b) apply the required changes to the rest of NN params 100P by using the affine function coefficient 140AC as elaborated herein (e.g., in relation to Eq. 2B).

In another example, system 10 may expedite the training process by employing an iterative training algorithm. In each iteration of this iterative training algorithm, system 10 may simultaneously infer the CMD model on the fly, while using the approximated model to deduce values of the network parameters.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of implementing a machine-learning (ML)-based function, the method comprising:
providing a Neural Network (NN) model comprising a plurality of NN parameters;
training the NN model over a plurality of training epochs, to implement a predefined ML function, based on a training dataset;
for one or more NN parameters of the plurality of NN parameters:
calculating a profile vector, representing evolution of the NN parameter through the plurality of training epochs; and
calculating an approximated value of the at least one NN parameter, based on the profile vector; and
replacing at least one NN parameter value in the trained NN model with a respective calculated approximated value, to obtain an approximated version of the trained NN model.

2. A method of training a NN model, the method comprising:
providing a NN model comprising a plurality of NN parameters;
training the NN model based on a training dataset over a plurality of training epochs, to implement a predefined ML function, wherein each training epoch comprises:
adjusting a value of at least one NN parameter based on gradient descent calculation;
calculating a profile vector, representing evolution of the at least one NN parameter through the plurality of training epochs;
calculating an approximated value of the at least one NN parameter, based on the profile vector; and
replacing the at least one NN parameter value with the approximated value, to obtain an approximated version of the NN model.

3. The method of claim 2, further comprising:
receiving an input data sample; and
inferring the approximated version of the NN model on the input data sample, to implement the ML function on the input data sample.

4. The method of claim 2, wherein said training comprises a preliminary stage comprising:
training the NN model based on a training dataset over a first bulk of training epochs;
grouping the plurality of NN parameters as members of a plurality of modes, based on their respective profile vectors; and
calculating the approximated values of NN parameters based on said grouping.

5. The method of claim 4, wherein grouping the plurality of NN parameters comprises:
for one or more pairs of NN parameters, calculating a correlation value representing a correlation between (i) a profile vector of a first NN parameter of the pair and (ii) a profile vector of a second NN parameter of the pair; and
grouping the plurality of NN parameters as members of modes based on the calculated correlation values.

6. The method of claim 4, further comprising for at least one mode of the plurality of modes:
selecting a first NN parameter, member of the at least one mode, as a reference NN parameter;
calculating a value of one or more affine function coefficients, representing a transform between the reference NN parameter and at least one second NN parameter, associated with the at least one mode; and
calculating the approximated value of the at least one second NN parameter based on: (i) the reference NN parameter, and (ii) the one or more corresponding affine function coefficient values.

7. The method of claim 4, further comprising, for at least one mode of the plurality of modes:
obtaining a reference profile vector, characterizing evolution of NN parameters of the mode through the plurality of training epochs;
calculating a value of one or more affine function coefficients, associated with one or more specific NN parameter of the mode, wherein said affine function coefficients represent a transform between (i) the profile vectors of the one or more specific NN parameters, and (ii) the reference profile vector; and
calculating the approximated value of the one or more specific NN parameters based on: (i) the reference profile vector, and (ii) the one or more affine function coefficient values.

8. The method of claim 7, wherein obtaining a reference profile vector comprises
identifying a central member NN parameter of the mode, as one located nearest a center of a multidimensional space defined by the mode; and
selecting the profile vector of the central member NN parameter as the reference profile vector.

9. The method of claim 7, wherein obtaining a reference profile vector comprises
identifying a central member NN parameter of the mode, as one having a minimal distance value from other member NN parameters of the mode, according to a predetermined distance metric; and
selecting the profile vector of the central member NN parameter as the reference profile vector.

10. The method of claim 7, wherein training the NN model further comprises, for at least one NN parameter of the plurality of NN parameters:
recalculating the associated affine function coefficient values between training epochs;
determining a status of stability of the affine function coefficient values, among consecutive training epochs, according to a predetermined stability metric; and
based on the stability status, refraining from calculating gradient descent of the at least one NN parameter.

11. A system for implementing a machine-learning (ML)-based function, the system comprising: a non-transitory memory device, wherein modules of instruction code are stored, and at least one processor associated with the memory device, and configured to execute the modules of instruction code, whereupon execution of said modules of instruction code, the at least one processor is configured to:
provide a NN model comprising a plurality of NN parameters;
train the NN model based on a training dataset over a plurality of training epochs, to implement a predefined ML function, wherein each training epoch comprises:
adjusting a value of at least one NN parameter based on gradient descent calculation;
calculating a profile vector, representing evolution of the at least one NN parameter through the plurality of training epochs;
calculating an approximated value of the at least one NN parameter, based on the profile vector; and
replacing the at least one NN parameter value with the approximated value, to obtain an approximated version of the NN model.

12. The system of claim 11, wherein the at least one processor is further configured to:
receive an input data sample; and
infer the approximated version of the NN model on the input data sample, to implement the ML function on the input data sample.

13. The system of claim 11, wherein said training comprises a preliminary stage, where the at least one processor is further configured to:
train the NN model based on a training dataset over a first bulk of training epochs;
group the plurality of NN parameters as members of a plurality of modes, based on their respective profile vectors; and
calculate the approximated values of member NN parameters based on said grouping.

14. The system of claim 13, wherein the at least one processor is further configured to group the plurality of NN parameters by:
for one or more pairs of NN parameters, calculate a correlation value representing a correlation between (i) a profile vector of a first NN parameter of the pair and (ii) a profile vector of a second NN parameter of the pair; and
group the plurality of NN parameters as members of modes based on the calculated correlation values.

15. The system of claim 13, wherein the at least one processor is further configured, for at least one mode of the plurality of modes, to:
select a first NN parameter, member of the at least one mode, as a reference NN parameter;
calculate a value of one or more affine function coefficients, representing a transform between the reference NN parameter and at least one second NN parameter, associated with the at least one mode; and
calculate the approximated value of the at least one second NN parameter based on: (i) the reference NN parameter, and (ii) the one or more corresponding affine function coefficient values.

16. The system of claim 13, wherein the at least one processor is further configured, for at least one mode of the plurality of modes, to:
obtain a reference profile vector, characterizing evolution of NN parameters of the mode through the plurality of training epochs;
calculate a value of one or more affine function coefficients, associated with one or more specific NN parameter of the mode, wherein said affine function coefficients represent a transform between (i) the profile vectors of the one or more specific NN parameters, and (ii) the reference profile vector; and
calculate the approximated value of the one or more specific NN parameters based on: (i) the reference profile vector, and (ii) the one or more affine function coefficient values.

17. The system of claim 16, wherein training the NN model by the at least one processor further comprises, for at least one NN parameter of the plurality of NN parameters:
recalculating the associated affine function coefficient values between training epochs;
determining a status of stability of the affine function coefficient values, among consecutive training epochs, according to a predetermined stability metric; and
based on the stability status, refraining from calculating gradient descent of the at least one NN parameter.
